(19) United States
(12) Patent Application Publication
(10) Pub. No.: US 2007/0182948 A1
(43) Pub. Date: Aug. 9, 2007

(54) SEMICONDUCTOR EXPOSURE METHOD AND METHOD OF CONTROLLING SEMICONDUCTOR EXPOSURE APPARATUS

(76) Inventors: Benjamin Szu-Min Lin, Hsinchu (TW); Sho-Shen Lee, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,448

(22) Filed: Feb. 8, 2006

(51) Int. Cl. G03B 27/32

(52) U.S. Cl. 355/77; 355/53; 355/30

(57) ABSTRACT

A semiconductor exposure method that uses a semiconductor exposure apparatus to expose a wafer is described. The semiconductor exposure apparatus comprises at least an exposure lens, a platform for supporting the wafer and a liquid-circulating device. The liquid-circulating device supplies a liquid to the space between the wafer and the exposure lens during exposure. One major feature of the present invention is that at least one aligning light source is used to perform an alignment operation for aligning the supporting platform before the actual exposure, wherein the aligning light source has a particular wavelength in which the effect on the aligning light source due to the evaporation of the liquid is minimized to prevent the liquid from affecting the alignment operation.

### BACKGROUND OF THE INVENTION

1. Field of the Invention

The present invention relates to a semiconductor exposure process. More particularly, the present invention relates to a semiconductor exposure method and a method of controlling a semiconductor exposure apparatus.

2. Description of the Related Art

With our increasing demand for higher level of integration in integrated circuits, the size of circuit devices continues to decrease. In the semiconductor manufacturing, the process most sensitive to device miniaturization is photolithography. In particular, the wafer exposure process in photolithography is one of the most important processes that have a direct effect on the pattern fidelity.

As semiconductor production enters the nanometer era, the resolution of the older generation of exposure apparatus has become severely inadequate. To resolve this problem, a technique called immersion exposure has been developed. In the immersion exposure process, the wafer is exposed through pure wafer. The advantage of this type of exposure apparatus can be realized using the following formula:
Resolution=k×λ/NA (1),

where k s a processing constant, λ is the wavelength of the light source in the exposure, NA is the numerical aperture. Furthermore, the numerical aperture can be represented by the following formula:
NA=n×sin θ, (2)

where n is the refractive index when the exposure light source passes through the dielectric, and θ is the incident angle of the exposure light source.

Therefore, with the same lens and under the same exposure light source condition, reducing the resolvable minimum distance or minimal resolution demands an increase in the NA value. To increase NA, one method is to increase the value of the refractive index n. For example, if the exposure light source is ArF, then using a medium having a refractive index larger than air (generally not greater than 1) such as a pure wafer (n is about 1.4) can reduce the minimal resolution.

FIG. 1 is a schematic cross-sectional view of a conventional exposure apparatus. As shown in FIG. 1, the aforementioned exposure apparatus comprises an exposure lens 100, a supporting platform 102 and a water-circulating device 104. The supporting platform 102 contains pure water 106 supplied by the water-circulating device 104. When a wafer 110 is placed on the supporting platform 102, the exposure lens 100 will come into contact with pure water 106 so that an expose to the wafer 110 is conducted through the pure wafer 106.

When this type of exposure apparatus is used to carry out an exposure, the supporting platform 102 is frequently moved to adjust the expose region of the wafer 110. Thus, before carrying out each exposure, the supporting platform 102 must be aligned to ensure the accuracy of the subsequent exposure location. However, because the supporting platform 102 contains pure water, the alignment accuracy provided by a conventional light source may be compromised due to the presence of wafer.

### SUMMARY OF THE INVENTION

Accordingly, at least one objective of the present invention is to provide a semiconductor exposure method that allows a supporting platform to be precisely aligned.

At least a second objective of the present invention is to provide a method of operating a semiconductor exposure apparatus that can precisely control the location of a supporting platform inside an immersion exposure apparatus.

To achieve these and other advantages and in accordance with the purpose of the invention, as embodied and broadly described herein, the invention provides a semiconductor exposure method suitable for exposing a wafer through an exposure apparatus. The semiconductor exposure apparatus comprises at least an exposure lens, a platform for supporting the wafer and a liquid-circulating device. The liquid-circulating device supplies a liquid to the space between the wafer and the exposure lens during exposure. One major feature of the present invention is that at least one alignment light source is used to perform an alignment operation for aligning the supporting platform before the actual exposure. The alignment light source has a particular wave length in which the effect on the alignment light source due to the evaporation of liquid is minimized to prevent the liquid from affecting the alignment operation.

According to the aforementioned semiconductor exposure method in the preferred embodiment of the present invention, the alignment operation includes aligning the light source with the X-axis and the Y-axis of the supporting platform.

According to the aforementioned semiconductor exposure method in the preferred embodiment of the present invention, the liquid-circulating device provides a liquid including pure water, glycerin or perfluoro polymer.

According to the aforementioned semiconductor exposure method in the preferred embodiment of the present invention, the light source for performing the alignment includes a XeCl, N₂, XeF, pulsed dye laser or a continuous wave (CW) laser.

According to the aforementioned semiconductor exposure method in the preferred embodiment of the present invention, the particular wavelength of the light source ranges between 300 nm and 450 nm.

According to the aforementioned semiconductor exposure method in the preferred embodiment of the present invention, the exposure apparatus includes a stepper exposure machine.

According to the aforementioned semiconductor exposure method in the preferred embodiment of the present invention, the exposure light source used in the exposure apparatus includes a laser.

The present invention also provides a method of operating a semiconductor exposure apparatus such as an exposure machine. The exposure machine includes at least an exposure lens, a platform for supporting a wafer and a liquid-circulating device. The liquid-circulating device supplies a liquid to the space between the wafer and the exposure lens during exposure. One major feature of the method is that at least one alignment light source is used to control the position of the supporting platform. The alignment light source has a particular wavelength, in which the effect on the light source due to the evaporation of liquid is minimized to prevent the liquid from affecting the positioning of the supporting platform.

According to the aforementioned method of operating the semiconductor exposure apparatus in the preferred embodiment of the present invention, the step for controlling the position of the supporting platform includes emitting a light beam from a first interferometer to detect the X-axis of the supporting platform and then emitting a light beam from a second interferometer to detect the Y-axis of the supporting platform.

According to the aforementioned method of operating the semiconductor exposure apparatus in the preferred embodiment of the present invention, the liquid-circulating device provides a liquid including pure water, glycerin or perfluoro polymer.

According to the aforementioned method of operating the semiconductor exposure apparatus in the preferred embodiment of the present invention, the above particular wavelength ranges between about 300 to 540 nm.

According to the aforementioned method of operating the semiconductor exposure apparatus in the preferred embodiment of the present invention, the light source includes a XeCl, N₂, XeF, pulsed dye laser or a continuous wave (CW) laser.

According to the aforementioned method of operating the semiconductor exposure apparatus in the preferred embodiment of the present invention, the exposure apparatus includes a stepper exposure machine.

According to the aforementioned method of operating the semiconductor exposure apparatus in the preferred embodiment of the present invention, the exposure light source used in the exposure apparatus includes a laser.

In the present invention, a light source having a wavelength set within a specified range is used to align or control the position of the supporting platform of the exposure apparatus. Hence, the liquid contained within the supporting platform is prevented from affecting the aligning operation. Consequently, the accuracy of the pattern transfer after the exposure process is improved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional exposure apparatus.

FIG. 2 is a flow diagram showing the steps for performing a semiconductor exposure process according to one preferred embodiment of the present invention.

FIG. 3 is a simplified diagram showing a method of operating a semiconductor exposure apparatus according to another preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

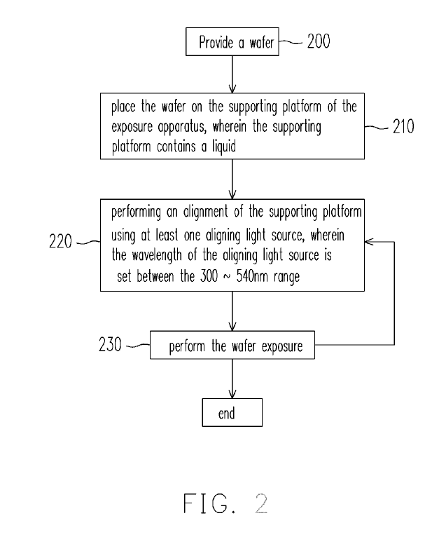

FIG. 2 is a flow diagram showing the steps for performing a semiconductor exposure process according to one embodiment of the present invention. As shown in FIG. 2, a wafer is provided in step 200. In general, a photoresist layer has already been coated on the wafer so that an exposure of the photoresist layer can be carried out.

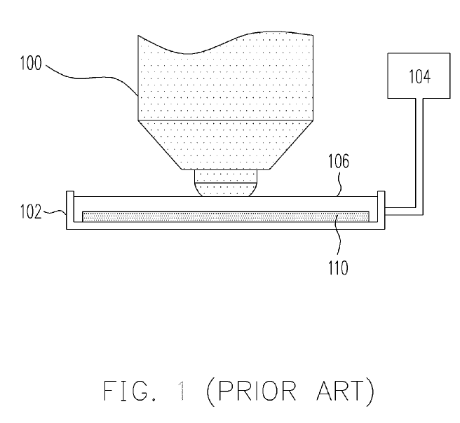

In step 210, the wafer is placed on a supporting platform containing a liquid inside an exposure apparatus. The exposure apparatus of the present embodiment includes at least an exposure lens, a platform for supporting the wafer and a liquid-circulating device. The liquid-circulating device supplies the aforementioned liquid to the space between the wafer and the exposure lens during exposure. The liquid such as pure water, glycerin or perfluoro polymer described in FIG. 1 is a medium having a refractive index higher than air. In addition, the present invention is not limited to the station shown in FIG. 1 and can be applied to other types of immersion exposure apparatus. For example, in some immersion exposure stations, liquid is only supplied to the space between the exposure lens and the wafer rather than the entire supporting platform. Some other immersion exposure apparatus may further include a liquid tank so that the entire supporting platform is totally immersed by the liquid within the liquid tank. Yet, it does not matter which type of immersion exposure apparatus is used, the exposure is likely to be affected by the evaporation of liquid in the ambient environment.

Because the wafer is disposed on the supporting platform, an alignment operation using at least a pair of aligning light sources is carried out to align the supporting platform in step 220 so that the wafer is precisely aligned with respect to the exposure lens. The aligning light source has a particular wavelength in which the effect on the aligning light source due to the evaporation of liquid is minimized. Further, the particular wavelength of the aligning light source is selected to be within a range that is the least interfered by the evaporation of liquid in the environment. In other words, the particular wavelength of the aligning light source is selected to be within a range that is less likely to be absorbed by the liquid to prevent the liquid from affecting the alignment operation. For example, when the liquid is pure water, the particular wavelength of the aligning light source is set within the 300˜540 nm range. The light source for performing the alignment includes, for example, XeCl, N₂, XeF, pulsed dye laser or a continuous wave (CW) dye laser. The aforementioned aligning operation includes aligning the aligning light source with the X-axis and Y-axis of the supporting platform.

In step 230, an exposure of the wafer is carried out using a laser as the light source. In the present embodiment, if the exposure apparatus is a stepper exposure machine, then the control is returned to step 220 after the first exposure to perform another alignment of the supporting platform and get ready for the next exposure. This process is repeated until the exposure for the entire wafer is completed.

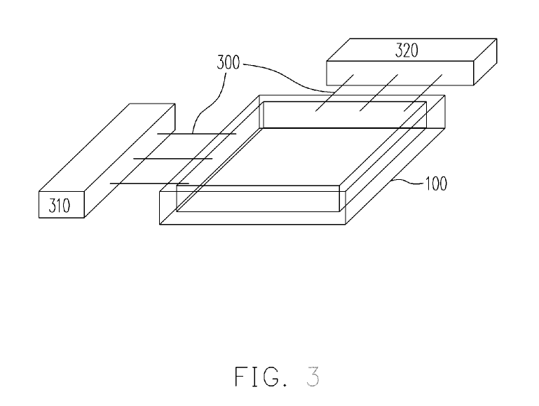

FIG. 3 is a simplified diagram showing a method of operating a semiconductor exposure apparatus according to another preferred embodiment of the present invention. As shown in FIG. 3, at least one light source 300 can be used to set the position of the supporting platform 100 within the immersion exposure apparatus described in FIG. 1, wherein the light source 300 has a particular wavelength in which the effect on the aligning light source due to the evaporation of liquid is minimized to prevent the liquid from affecting the positioning of the supporting platform 100. For example, the step for positioning the supporting platform 100 includes shining a light beam 300 from a first interferometer 310 to detect the X-axis of the supporting platform 100 and shining another light beam 300 from a second interferometer 320 to detect the Y-axis of the supporting platform 100. When the liquid is pure wave, the particular wavelength of the aforementioned light source 300 can be set within the range 300˜540 nm generated by XeCl, N₂, XeF, pulsed dye laser or continuous wave (CW) dye layer, for example. Furthermore, the type of exposure apparatus, exposure light source and supplied liquid can be identical to the previous embodiment but should not be used to limit the scope of the present invention. The supplied liquid can also be glycerin, fully chlorinated polymers with a refraction ratio higher than air.

In summary, the present invention uses a light source having a wavelength set within a specified range to align or control the position of the supporting platform of the exposure apparatus. Hence, the liquid contained within the supporting platform is prevented from affecting the aligning operation. Consequently, the accuracy of the pattern transfer after the exposure process is improved. In other words, the method in the present invention is advantageous to the fabrication of nanometer grade semiconductor devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A semiconductor exposure method for exposing a wafer using an exposure apparatus having at least an exposure lens, a platform for supporting a wafer and a liquid-circulating device, wherein the liquid-circulating device provides a liquid to the space between the exposure lens and the wafer during the exposure, major characteristics of the method comprising:
performing an alignment of the supporting platform using at least a pair of aligning light source, wherein the aligning light source has a particular wavelength in which an effect of an evaporation of the liquid on the aligning light source is minimized to prevent the liquid from affecting the aligning operation.

2. The semiconductor exposure method of claim 1, wherein the aligning operation includes aligning the aligning light source with the X-axis and the Y-axis of the supporting platform.

3. The semiconductor exposure method of claim 1, wherein the liquid supplied by the liquid-circulating device is selected from a group consisting of pure wafer, glycerin and perfluoro polymer.

4. The semiconductor exposure method of claim 1, wherein the aligning light source includes Xe, N₂, NeF, pulsed dye laser or continuous wave (CW) dye laser.

5. The semiconductor exposure method of claim 1, wherein the particular wave length is set between a range of about 300 to 540 nm.

6. The semiconductor exposure method of claim 1, wherein the exposure apparatus includes a stepper exposure machine.

7. The semiconductor exposure method of claim 1, wherein the light source used for exposing the wafer inside the exposure apparatus includes a laser.

8. A method of operating a semiconductor exposure apparatus having at least an exposure lens, a platform for supporting a wafer and a liquid-circulating device, wherein the liquid-circulating device supplies a liquid to the space between the exposure lens and the wafer during the exposure, the major characteristics of the method including:
controlling the position of the supporting platform using at least one light source, wherein the light source has a particular wavelength in which an effect of an evaporation of the liquid on the aligning light source is minimized to prevent the liquid from affecting the positioning of the supporting platform.

9. The method of operating the semiconductor exposure apparatus of claim 8, wherein the light source includes Xe, N N₂, NeF, pulsed dye laser or continuous wave (CW) dye laser.

10. The method of operating the semiconductor exposure apparatus of claim 8, wherein the particular wavelength is set at a range between 300 to 540 nm.

11. The method of operating the semiconductor exposure apparatus of claim 8, wherein the step of positioning the supporting platform includes:
shining a light beam from a first interferometer to detect the X-axis of the supporting platform; and
shining a light beam from a second interferometer to detect the Y-axis of the supporting platform.

12. The method of operating the semiconductor exposure apparatus of claim 11, wherein the light source includes Xe, N₂, NeF, pulsed dye laser or continuous wave (CW) dye laser.

13. The method of operating the semiconductor exposure apparatus of claim 8, wherein the liquid supplied by the liquid-circulating device is selected from a group consisting of pure wafer, glycerin and perfluoro polymer.

14. The method of operating the semiconductor exposure apparatus of claim 8, wherein the exposure apparatus includes a stepper exposure machine.

15. The method of operating the semiconductor exposure apparatus of claim 8, wherein the light source used for exposing a wafer inside the exposure apparatus includes a laser.
